(19) United States
(12) Patent Application Publication
(10) Pub. No.: US 2018/0076504 A1
(43) Pub. Date: Mar. 15, 2018

(54) ANTENNA FEEDER CONFIGURED FOR FEEDING AN ANTENNA INTEGRATED WITHIN AN ELECTRONIC DEVICE

(71) Applicant: THOMSON Licensing, Issy-lesMoulineaux (FR)

(72) Inventors: Dominique LO HINE TONG, Rennes (FR); Philippe Minard, Saint Medard Sur Ille (FR); Anthony Aubin, Bourgbarre (FR)

(21) Appl. No.: 15/698,601

(22) Filed: Sep. 7, 2017

(30) Foreign Application Priority Data
Sep. 9, 2016 (EP) 16306134.4

(51) Int. Cl. H01Q 1/24; H01Q 13/18; H01Q 9/04

(52) U.S. Cl. CPC H01Q 1/24; H01Q 9/045; H01Q 13/18

(57) ABSTRACT

An antenna feeder configured for feeding a slot antenna integrated within a housing of an electronic device comprising a printed circuit board is disclosed. The printed circuit board includes a driving circuit for the antenna feeder. The slot antenna has a slot with first and second longitudinal edges. The antenna feeder includes a transmission line forming at least one RF current loop, a part of a surface of the at least one RF current loop facing the slot for electromagnetically coupling the antenna feeder to the slot.

### 1. REFERENCE TO RELATED EUROPEAN APPLICATION

This application claims priority from European Patent Application No. 16306134.4, entitled, “ANTENNA FEEDER CONFIGURED FOR FEEDING AN ANTENNA INTEGRATED WITHIN AN ELECTRONIC DEVICE”, filed on Sep. 9, 2016, the contents of which are hereby incorporated by reference in its entirety.

### 2. FIELD OF THE DISCLOSURE

The field of the disclosure is that of techniques for feeding antennas integrated in electronic devices.

More specifically, the disclosure relates to an antenna feeder for feeding slot or patch antennas formed in the casing of such electronic devices.

The disclosure can be of interest in any field where electronic devices integrate wireless features such as WiFi, Bluetooth, RF4CE, ZigBee, Zwave, LTE, etc., as for instance in home-networking electronic devices, such as Internet gateways, set-top-boxes, routers and smart home devices.

### 2. TECHNOLOGICAL BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Home-networking devices such as Internet gateways, set-top-boxes, routers and smart home devices integrate numerous wireless systems in order to offer multiple services and applications. These include different systems complying with various communication standards such as, for example, WiFi, Bluetooth, RF4CE, ZigBee, Zwave, LTE, etc.

It appears that the casing of such devices tends to evolve toward metal material for various reasons, e.g.:
for proposing an aesthetical product with a metal high-end finishing metal surface;
for proposing a heavy product with a high stability;
for proposing a thinner product while being robust;
for proposing a product with a more efficient thermal management;
for proposing an increased isolation from the noise embedded in the electronic product;
for managing any ElectroMagnetic Compatibility (EMC) issues.

However, such environment requires a high level of antenna integration in order to preserve antenna performances.

Slot or patch antennas, as well as cavity-backed slot or patch antenna are widely used in the context of electronic devices. Classically, the feeding of such antennas can be made using spring metal sheet that needs to be connected in an efficient way from the printed circuit board (PCB) toward the antenna in order to maximize the antenna efficiency.

In particular, Knorr, J. B., has described the theoretical aspect of classical technique for feeding a radiating slot in “Slotline transitions”, IEEE Trans., 1974. By extension this feeding technique can be applied to feed a slot antenna, where the slot antenna is either ended with an open circuit plane (as for example a tapered slot antenna) or with a short circuit plane with a slot length for example to target the fundamental mode of a half-guided wavelength. In order to maximize the coupling between the radiating slot and the transmission line, which defines the transition plane, the electric field in the slot has to be maximized and the magnetic field in the transmission line has to be maximized. To maximize the magnetic field of the transmission line in the transition plane, there are two main methods:
The first method uses a transmission line extended after the transition plane by a guided quarter wavelength long;
The second method uses a transmission line short-circuited to ground just after crossing the slot line.

It must be noted that the first method has a narrower frequency bandwidth behavior than the second method due to the frequency dependency of the extended transmission line. The second method needs a good ground connection with a connection at the opposite slot side of the transmission line feeding port.

Similar feeding techniques are classically used with patch antenna.

However, in now trending casing as discussed above, the slot or patch antenna may be formed either in the metal casing or by both metal mechanical parts of the casing. For instance, a first sub-part of the casing forms a first edge of the slot and a second sub-part forms a second edge of the slot.

But in that later case the feeding of the antenna must be guaranteed while the antenna is formed when the assembly of the casing is performed. In other words, the feeding of the antenna must be done in a blind way, as the antenna itself does not exist before the casing is assembled, and the interior of the casing may be not accessible after this assembly of the casing.

The same problem holds when the antenna is formed directly in the metal casing as the PCB embedding the components providing (respectively retrieving) signals to (respectively from) the antenna may be put in place during the assembly of the electronic device, and the interior of the casing may be inaccessible after the assembly of the casing. Depending on the location of the antenna on the casing and the location of the PCB inside the casing, classical techniques for feeding slot or patch antenna as discussed above may not be usable.

More particularly, when the slot or patch antenna is not aligned with the feeding point, the feeder may low couple to the antenna for many reasons when the casing is assembled and closed in a blind way. For instance:
the feeding may not respect the distance with the antenna;
the feeding may not be correctly connected to the Printed circuit board.

There is thus a need for a system allowing to feed efficiently a slot or patch antenna located on the casing of an electronic device from a PCB embedded in the casing.

There is a need for this system to result in an efficient feeding while been mounted in a blind way during the assembly of the casing.

### 3. SUMMARY

A particular aspect of the present disclosure relates to an electronic device comprising a slot antenna formed by a slot comprising first and second longitudinal edges, an antenna feeder configured for feeding said slot antenna, a driving circuit for said antenna feeder, characterized in that the slot antenna comprises a transmission line forming at least one RF current loop, a part of a surface of said at least one RF current loop facing said slot for electromagnetically coupling said antenna feeder to said slot.

Thus, the present disclosure proposes a new and inventive solution for the feeding of slot or patch antennas integrated in the casing of an electronic device, thus allowing the blind mounting of the feeder that electromagnetically couples the antenna to the electronic circuitry disposed on a printed circuit board within the casing. For that, at least one RF current loop is formed (by the transmission line, i.e. the feeder), a part of which faces the slot.

In a particular embodiment, said housing is metallic or metallized and said slot is formed in said metallic or metallized housing.

In an alternate embodiment, said housing is non-metallic and said slot is formed in an electrical surface of an element different from said housing (e.g. this element is realized according to a printed circuit board technology or a metal stamping technology).

In a particular embodiment, said housing comprises a first part of housing integrating said first longitudinal edge and a second part of housing integrating said second longitudinal edge, and said transmission line is configured to be held mechanically by a support integrated to, or attached and electrically connected to, said first part of housing.

Thus, since there is neither mechanical nor electrical connection between the feeder and the second part of housing, it is easy to obtain a correct positioning of the feeder in respect of the slot for insuring a good electromagnetic coupling, even though the mounting of the first part of housing and second part of housing is performed blindly.

According to a particular feature, said transmission line comprises at least two RF current loops, a part of a surface of each of said at least two RF current loops facing said slot for electromagnetically coupling, in a particular frequency band, said antenna feeder to said slot.

Thus, the electronic device can operate as a multiband device.

In a first particular implementation, said transmission line comprises:
a common part configured to be electrically connected to said driving circuit;
a first extending part, extending from said common part and ending by a first RF short-circuit via an electrical connection to a conducting element; and
at least one second extending part, extending from said common part and ending by a second RF short-circuit via an electrical connection to said conducting element;

said first and second RF short-circuits being located on a same side of said first longitudinal edge.

Thus, the transmission line (i.e. the feeder) is easy to implement.

According to a particular feature, said first extending part doesn't cross said first longitudinal edge, and said at least one second extending part crosses an even number of times said first longitudinal edge.

Thus, the transmission line (i.e. the feeder) can be implemented with many different patterns for the at least one RF current loop.

According to a particular feature, said first extending part has a length lower than one tenth of a guided wavelength at a working frequency f1.

This feature participates to an optimal electromagnetic coupling.

According to a particular feature, said at least one second extending part has a length lower than one quarter of a guided wavelength at a working frequency f1.

This feature participates to an optimal electromagnetic coupling.

According to a particular feature, said transmission line comprises at least two second extending parts each participating to a particular RF current loop, and wherein each second extending part has a length higher than half of a guided wavelength at a particular working frequency (f2, f3, . . . , fi).

This feature participates to an optimal electromagnetic coupling, for each of the plurality of RF current loops.

According to a particular feature, said at least one second extending part crosses an even number of times said second longitudinal edge.

Thus, the transmission line (i.e. the feeder) can be implemented with many different patterns for the at least one RF current loop. This feature also participates to an optimal electromagnetic coupling, since the part of the at least one RF current loop which faces the slot is increased.

In a second particular implementation, said transmission line comprises:
a first part electrically connected to said driving circuit; and
a second part extending from the first part and having a form of a loop configured for partially facing said slot.

In this second particular implementation, there is no need for short-circuits (via electrical connections to the metallic housing) between parts of the transmission line.

In a particular implementation, said transmission line is realized according to a printed circuit board technology.

Using he PCB technology allows to easily realize the transmission line (i.e. the feeder).

In an alternate implementation, said transmission line is a piece of metal or a metalized plastic element.

Thus, the implementation of the transmission line (i.e. the feeder) is not limited to the PCB technology.

According to a particular feature, said transmission line comprises at least one active component for realizing a frequency and/or radiation pattern tunable slot antenna.

Thus, the functionalities of the antenna, and therefore the electronic device, are increased.

### 4. LIST OF FIGURES

Other features and advantages of embodiments shall appear from the following description, given by way of indicative and non-exhaustive examples and from the appended drawings, of which:

FIG. 1a illustrates a perspective view of a wireless communication device according to an embodiment of the present disclosure;

FIG. 1b illustrates the assembly of the different parts of the wireless communication device of FIG. 1a, comprising the top housing, the spacer, the optional shielding, the printed circuit board and the bottom housing;

FIGS. 2a, 2b, 2c and 2d illustrate respectively a perspective view of the top housing, of the spacer, of the printed circuit board and of the bottom housing disclosed in FIG. 1b;

FIGS. 3a, 3b and 3c illustrate an antenna feeder according to embodiments of a first variant of the present disclosure;

FIGS. 4a, 4b, 4c, 4d and 4e illustrate antenna feeders according to embodiments of a second variant of the present disclosure.

### 5. DETAILED DESCRIPTION

In all of the figures of the present document, the same numerical reference signs designate similar elements and steps.

The general principle of the disclosed method consists in an antenna feeder for feeding a slot antenna comprising first and second longitudinal edges and integrated within a metallic housing of an electronic device. Such feeder comprises a transmission line forming at least one RF current loop, a part of a surface of this at least one RF current loop facing the slot (i.e. the radiating aperture of the slot antenna) for electromagnetically coupling the antenna feeder to the slot.

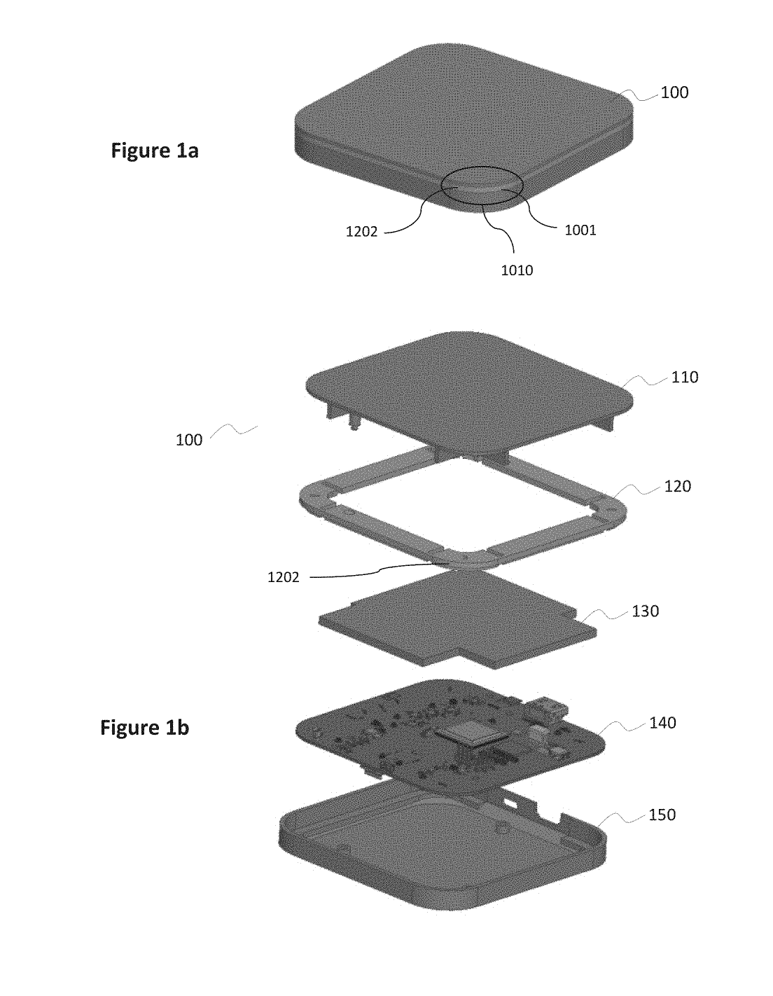

Referring now to FIG. 1a, we present a perspective view of a wireless communication device according to embodiments of the present disclosure.

In the present embodiment, the device 100 is a set top box. It comprises four 5 GHz antennas for WiFi and one 2.4 GHz antenna for Bluetooth wireless communications, although not illustrated in FIG. 1A. Connectivity to other devices, such as a television for rendering, is provided through various connectors such as Universal Serial Bus type-C (USB-C) or High-Definition Multimedia Interface (HDMI). The device integrates decoding capabilities of audiovisual signals received either through the wireless communication or through the physical connectors as well as interaction with the user through a user interface. The housing of the device is mainly made of metal, therefore making it challenging to integrate wireless communication capabilities with good performances.

A slot antenna 1010 is present on each of the four corners of the casing of the device 100. As disclosed below in relation with FIG. 1b, the radiating aperture 1001 of the slot antenna (i.e. the slot itself, in the meaning of the physical slot aperture in the metal casing) is filled with a part 1202 of a spacer (120) made of dielectric material, thus allowing reducing the electrical length of the radiating slot aperture.

In other embodiments, slot antennas may be present or added at other locations by creating other apertures. Patch antenna(s) may also be considered in addition or in place of slot antenna(s) as disclosed below in relation with FIG. 5.

Referring now to FIG. 1b, we present an exploded view showing the assembly of the different parts of the wireless communication device 100 of FIG. 1a.

A top housing 110 is realized in metal, either by using die casting or machining techniques and forms the first part of the cavity-backed antenna. A spacer 120 allows forming a gap between the top housing 110 and the bottom housing 150, resulting for example in one of the four slot antennas 1010. This spacer is preferably realized in dielectric material (ABS material for example) that reduces the antenna sizes, but can be also an air-filled zone that can increase the antenna efficiency. The gap width controls both the antenna bandwidth and efficiency. In the present embodiment, the part 1202 of the spacer 120 is configured for filling the radiating aperture 1001 of the slot antenna, thus allowing reducing the electrical length of the radiating slot aperture. This mechanical part can be realized by molded injection technique. An optional shielding 130 is soldered or fixed onto a printed circuit board 140 to reduce noise in the device. An optional thermal pad can be applied between an electronic component and one or both metal parts of the housing. The inner sides of the top and/or bottom housing can be mechanically matched in order to reduce the thermal pad height for cost saving reasons. The printed circuit board 140 forms the second part of the cavity-backed antenna. In this cavity surface area, the printed circuit board comprises at least one conductive layer. A bottom housing 150 is realized in metal, either by using die casting or machining techniques and forms the third part of the cavity-backed antenna. The cavities are therefore formed by the assembly of the top housing, the printed circuit board and the bottom housing. Each cavity is linked from RF circuitry to an antenna conductor feeder that is either directly connected with the top and/or the bottom housing forming the (slot) antenna or electromagnetically coupled to the (slot) antenna.

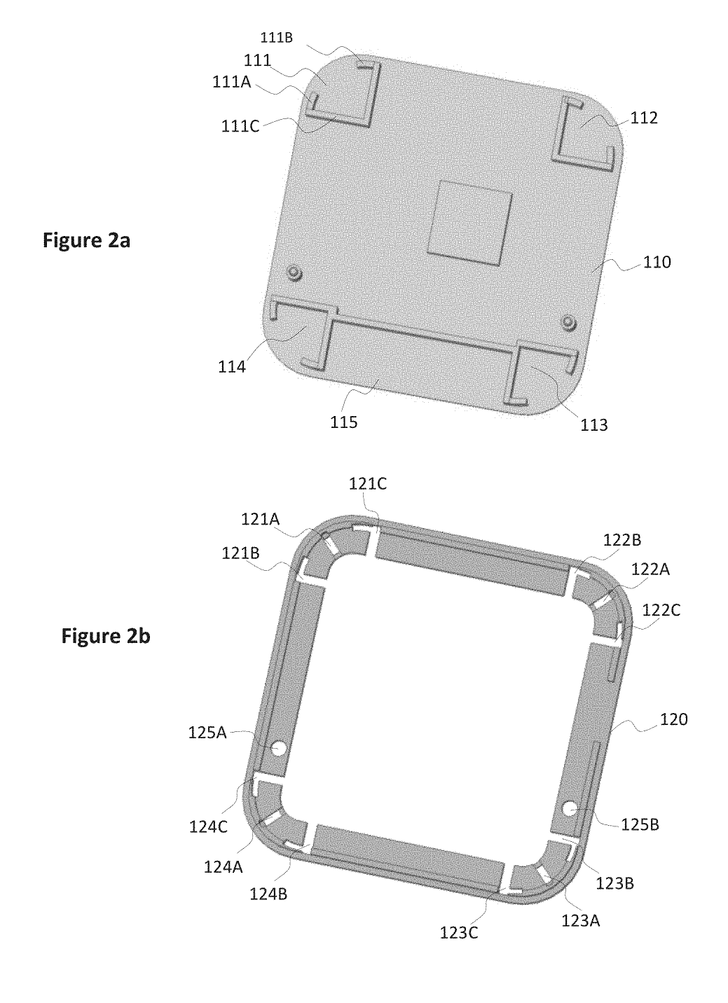

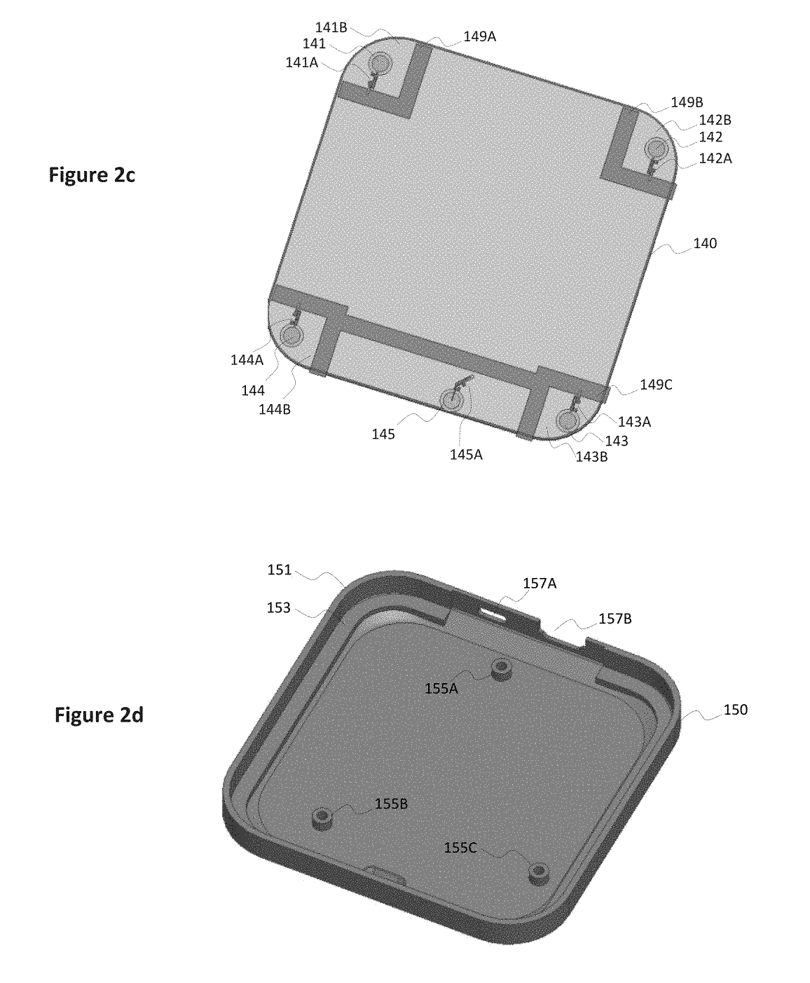

Referring now to FIGS. 2a, 2b, 2c and 2d, we present perspective views of the top housing 110, of the spacer 120, of the printed circuit board 140 and of the bottom housing disclosed 150 in FIG. 1b.

More particularly, areas 111, 112, 113, 114 are representing the cavities of the 5 GHz antennas. Taking the example of cavity 111, the first part of the cavity is formed by the surface of the top housing 110, completed by the side walls 111A, 1113 and by the rear wall 111C. These walls are either formed in the top surface or fixed to the top surface as a separate metallic part. In order to enable wide band frequency applications, the quality factor of the cavity should be minimized. The side walls allow the adjustment of the resonating frequency of the cavity-backed antenna. The form and dimension of the walls is determined by simulations according to the overall form of the device. The four 5 GHz cavities are arranged to propose a radiation pattern diversity so as for example to propose a complementary radiation pattern in the horizontal plane of the device. Higher MIMO order can be addressed with this arrangement by adding slot aperture on the same device edge (between current 5 GHz antennas in each corner), or by creating additional aperture in this first part of the metal housing. The cavity 115 is dedicated to 2.4 GHz. The principles described above apply for this cavity.

The spacer 120 comprises multiple cuts and openings in the dielectric. Openings 121A, 122A, 123A, 124A are arranged to support the antenna feeder. Cuts 1213, 121C, 1223, 122C, 1233, 123C, 1243, 124C are arranged to insert the top housing and are particularly adapted to fit to the walls integrated into the top housing. Optionally, holes 125A, 1253 are arranged to allow insertion of the top housing and to provide guidance for positioning and maintaining the spacer towards the top housing.

The printed circuit board 140 hosts the electronic components that provide the functionality of the device. These components are not shown in the figure. It comprises conductor pads 141, 142, 143, 144, 145 allowing the contact of an antenna feeder (not represented) to the slot antenna, antenna driving circuits 141A, 142A, 143A, 144A, 145A. The cavity areas 141B, 142B, 143B, 144B use filled conductor and plated through holes may be added to increase the energy transfer from the printed circuit board to the antenna. Ground planes 149A, 149B, 149C are arranged on the top layer of the printed circuit board, coating-free, to ensure good ground connection with the walls of the top cover. Indeed, electric contacts between the printed circuit board and the walls of the top cover ensure an electromagnetic sealing of the cavity. The contact points between the printed circuit board and the wall of the top housing are distant by less than a quarter of the wavelength and preferably the contacts are nearly continuous, for example through the use of metallic foam. The person skilled in the art will appreciate that several solutions may be used to ensure the electrical connection between the wall of the top cover and the ground plane on the printed circuit board such as spring contacts, solder paste, or metallic foam.

The vertical part 151 and the horizontal part 153 of the bottom housing 150 form the third part of the cavities for each of the cavity-backed antennas. Indeed, the horizontal part is required to close the cavity since the printed circuit board does not fit perfectly to the vertical part: some free space needs to be provisioned around the printed circuit board to allow its assembly. Optionally, holes 155A, 155B, 155C are used to fix the printed circuit board onto the bottom housing 150 and holes 157A, 157B are used to interface the device with external elements by connecting cables or devices, such as DC power unit, HDMI, USB, USB-C, etc. Optionally, the bottom housing can also integrate walls similar to the walls integrated to the top housing in order to further improve the isolation of the cavities.

The person skilled in the art will appreciate that other arrangements of the different elements composing the device are possible. For example, when the device is standing up (being mostly vertical and not mostly horizontal as described in the FIG. 1A), the top and bottom housings are replaced by left and right housings or front and rear housings, without altering the principle of the invention. The position of the antennas can also be changed with minor impact of the performances. For example, the 5 GHz antennas could be placed in the middle of each side of the device and the 2.4 GHz antenna could be placed in a corner of the device. Any other number of (slot or patch) antennas could be used. For example, doubling the number of antennas of the preferred embodiment using 8 antennas for the 5 GHz and 2 for the 2.4 GHz, the antennas being distributed over the sides, corner, and top of the housing.

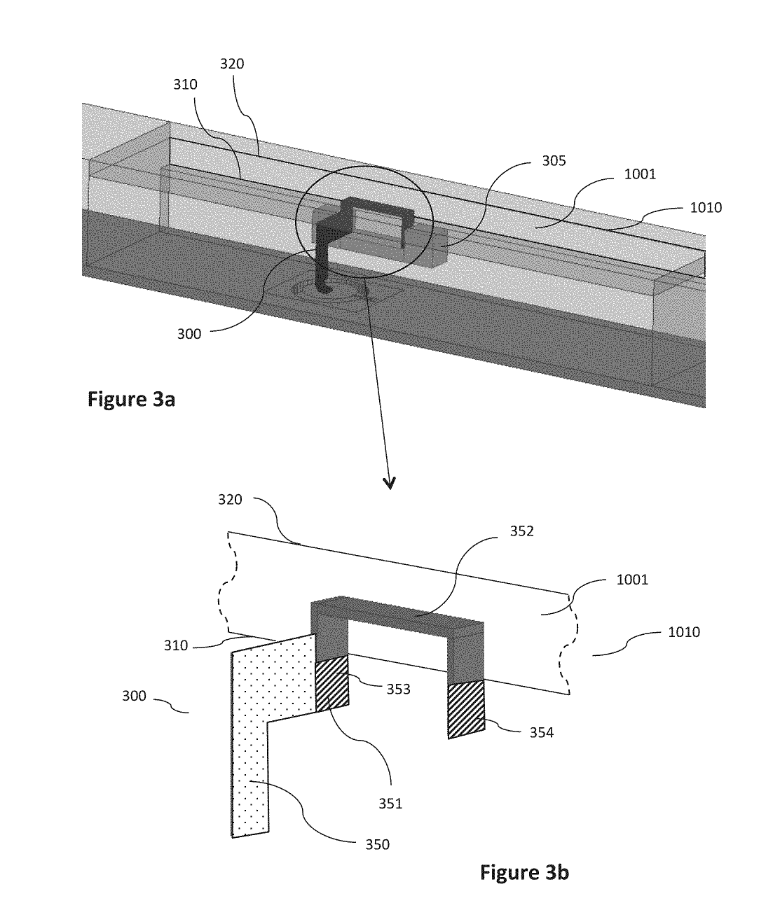

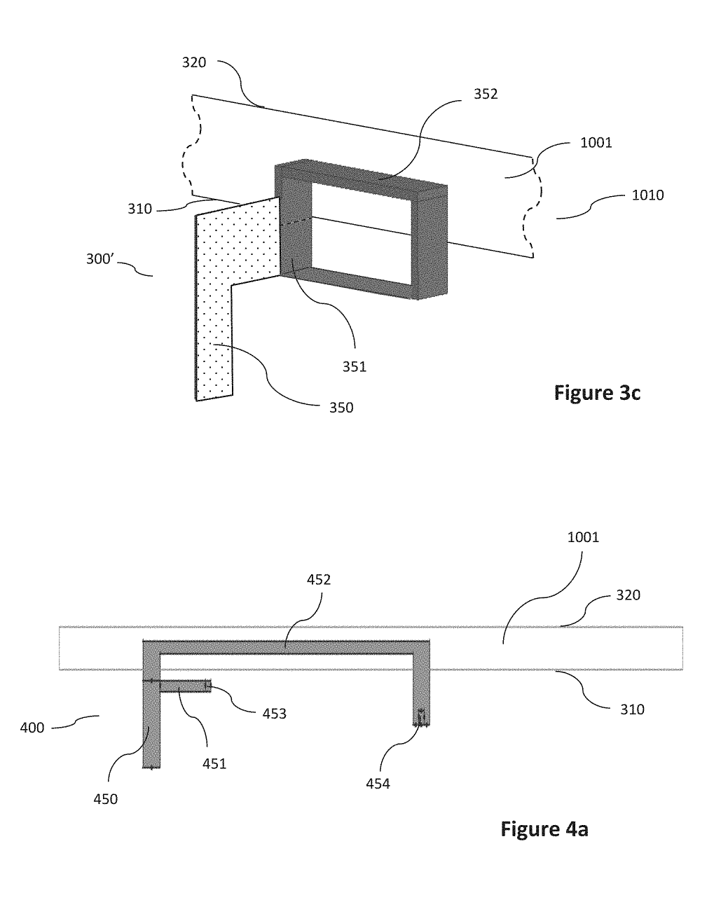

Referring now to FIGS. 3a and 3b, we present an antenna feeder according to an embodiment of a first variant of the present disclosure.

In the present variant, the antenna feeder 300 is an electrically conducting element (whether a metalized plastic element or an element made of any suitable metal known by the person skilled in the art) configured for being in contact with the conductor pads 141, 142, 143, 144, 145 in order to couple electromagnetically the signal delivered by an antenna driving circuit 141A, 142A, 143A, 144A, 145A (present on the PCB 140) to the radiating aperture (slot) 1001 of the slot antenna 1010, and vice-versa.

A first 310 and a second 320 longitudinal edge delimit the radiating aperture 1001 of the slot antenna 1010.

In a particular implementation, with a metallic two-parts housing, the first part of housing 110 integrates the first longitudinal edge 310 and the second part of housing 150 integrates the second longitudinal edge 320. As such, the radiating aperture 1001 of the slot antenna 1010 is formed during the mounting of the casing of the device 100 as disclosed above in relation with FIGS. 1a and 1b. The housing of the device thus behaves as the ground plane for the slot antenna.

The antenna feeder 300 according to the present embodiment comprises a transmission line configured to be held mechanically by a support 305 integrated to, or attached and electrically connected to, the first part of housing 110. Consequently, there is neither mechanical nor electrical connection between the antenna feeder 300 and the second part of housing 150. It is thus easy to obtain a correct positioning of the antenna feeder 300 in respect of the radiating aperture 1001 for insuring a good electromagnetic coupling, even though the mounting of the first part 110 of housing and second part of housing 150 is performed blindly.

The transmission line of the antenna feeder 300 comprises:
a common part 350 configured to be electrically connected to the driving circuit 141A, 142A, 143A, 144A, 145A present on the PCB 140;
a first extending part 351, extending from the common part 350 and ending by a first RF short-circuit 353 via an electrical connection to the metallic support (“conducting element”) 305 (more particularly, in the present case, all of the first extending part 351 is in short-circuit as being in contact with the metallic support 305; the electrical length of the first extending part 351 is thus close to zero in the present case); and
one second extending part 352, extending from the common part 350 and ending by a second RF short-circuit 354 via an electrical connection to the metallic support (aforesaid “conducting element”) 305.

The first 353 and second RF short-circuits 354 are furthermore located on a same side of the first longitudinal edge 310. Consequently, the RF current fed by (or retrieved from) the driving circuit 141A, 142A, 143A, 144A, 145A going through the common part 350 and the second extending part 352 can return back to the common part 350 via the metallic support, and via the first extending part 351. A RF current loop is thus formed as such, allowing the electromagnetic coupling of the antenna feeder 300 with the radiating aperture 1001 of the slot antenna 1010.

The second extending part 352 is extending along an area in view of the radiating aperture 1001 so that only a fraction of the electrical surface of the RF current loop facing the radiating aperture 1001 participates effectively to the electromagnetic coupling between the antenna feeder and the radiating aperture 1001 of the slot antenna 1010.

With the present definitions of the first 351 and second 352 extending parts, it appears that the first extending part 351 doesn't cross the first longitudinal edge 310, and that the second extending part 352 crosses an even number of times the first longitudinal edge 310.

In order to achieve an optimal electromagnetic coupling of the antenna feeder 300 to the radiating aperture 1001, the first extending part 351 may have a length lower than one tenth of a guided wavelength at a working frequency f1 (i.e. at the carrier frequency of the RF signal delivered/retrieved by the driving circuit 141A, 142A, 143A, 144A, 145A).

In the same way, the second extending part 352 has preferably a length lower than one quarter of a guided wavelength at a working frequency f1, knowing that an increase of this length create a frequency shift toward lower frequency of the optimal coupling frequency between the antenna feeder 300 and the radiating aperture 1001.

Referring now to FIG. 3c, we present an antenna feeder according to another embodiment of a first variant of the present disclosure.

In the present embodiment, the first extending part 351 extends toward the end of the first extending part 352, thus allowing a creation of an electrical loop independently of the nature of the support 305. Consequently, even if the support is made of dielectric material, the RF current fed by (or retrieved from) the driving circuit 141A, 142A, 143A, 144A, 145A going through the common part 350 and the second extending part 352 can return back to the common part 350 directly via the first extending part 351. A RF current loop is thus formed in the antenna feeder independently of the support 305 and the bottom part of the casing 150, allowing the electromagnetic coupling of the antenna feeder 300 to the radiating aperture 1001 of the slot antenna 1010.

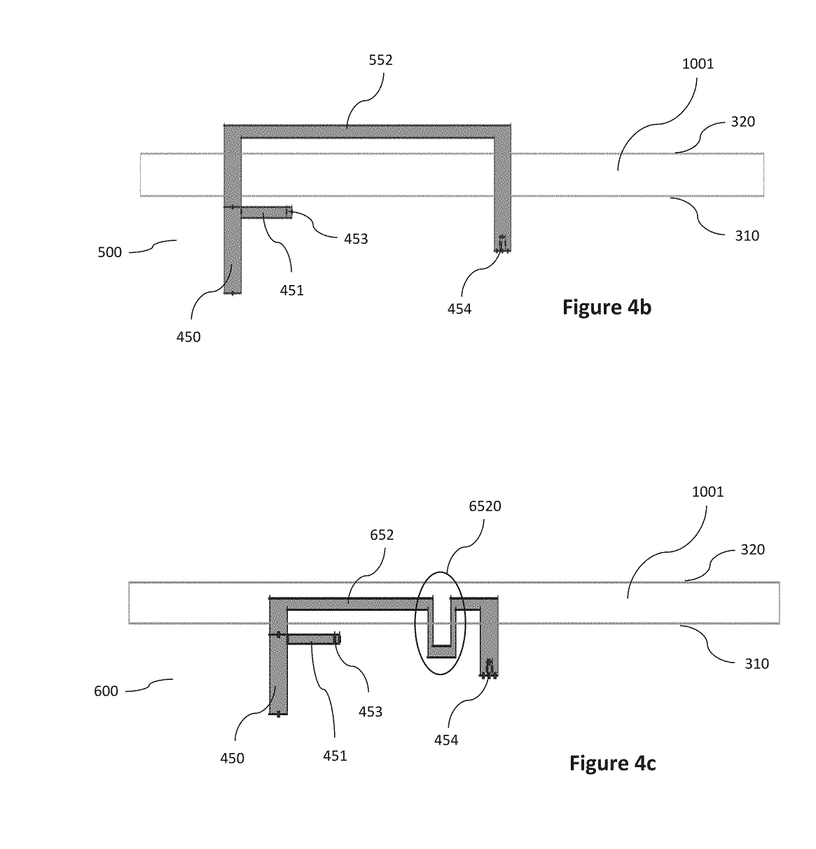

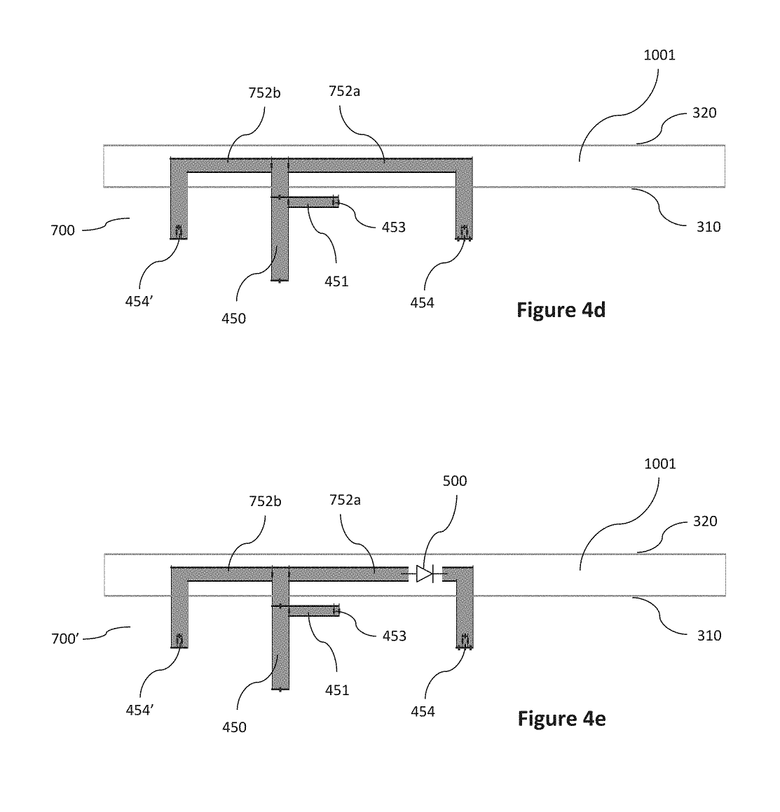

Referring now to FIG. 4a, we present an antenna feeder according to an embodiment of a second variant of the present disclosure.

In the present variant, the antenna feeder 400 is made in PCB technology and can be part of the PCB 140 embedding the electronic components of the device 100, or be implemented on a separate PCB connected to the PCB 140.

In both case, the antenna feeder 400 is configured for being in contact with the conductor pads 141, 142, 143, 144, 145 in order to couple electromagnetically the signal delivered by an antenna driving circuit 141A, 142A, 143A, 144A, 145A present on the PCB 140 to the radiating aperture 1001 of the slot antenna 1010, and vice-versa, via a transmission line.

The transmission line of the antenna feeder 400 comprises:
a common part 450 configured to be electrically connected to the driving circuit 141A, 142A, 143A, 144A, 145A present on the PCB 140;
a first extending part 451, extending from the common part 450 and ending by a first RF short-circuit 453 via an electrical connection to the ground plane (“conducting element”) of the PCB the antenna feeder 400 is made of; and
one second extending part 452, extending from the common part 350 and ending by a second RF short-circuit 454 via an electrical connection to the ground plane (aforesaid “conducting element”).

The RF short-circuits 453 and 454 can be implemented using any technology well-known from the person skilled in the art, e.g. plated through holes connecting the printed extending parts to the ground plane.

As for the embodiment disclosed in relation with FIGS. 3a and 3b, the first 453 and second RF short-circuits 454 are located on the same side of the first longitudinal edge 310 so that the RF current fed by (or retrieved from) the driving circuit 141A, 142A, 143A, 144A, 145A going through the common part 450 and the second extending part 452 can return back to the common part 450 via the ground plane, and via the first extending part 451. A RF current loop is thus formed as such, allowing the electromagnetic coupling of the antenna feeder 400 to the radiating aperture 1001 of the slot antenna 1010.

The same design guidelines as disclosed in relation with FIGS. 3a and 3b for the lengths of the first extending part 451 and the second extending part 452 hold in the present embodiment relying on PCB technology.

Referring now to FIG. 4b, we present an antenna feeder according to another embodiment of the second variant of the present disclosure.

In the present embodiment, the second extending part 552 of the antenna feeder 500 extends beyond the second 320 longitudinal edge delimiting the radiating aperture 1001 of the slot antenna 1010.

Consequently, almost all of the electrical surface of the RF current loop (allowing the RF current fed by (or retrieved from) the driving circuit 141A, 142A, 143A, 144A, 145A going through the common part 450 and the second extending part 552 to return back to the common part 450 via the ground plane, and via the first extending part 451) facing the radiating aperture 1001 participates effectively to the electromagnetic coupling between the antenna feeder and the radiating aperture 1001 of the slot antenna 1010. The electromagnetic coupling is therefore maximized.

Referring now to FIG. 4c, we present an antenna feeder according to another embodiment of the second variant of the present disclosure.

In the present embodiment, the second extending part 652 of the antenna feeder 600 presents a “U” shaped transition 6520 allowing adapting both the impedance of the overall current loop (composed of the common part 450, the second extending part 652 and the RF electrical path in the ground plane to go back to the common part 450 via the first extending part 451) as well as the efficiency in the coupling with the radiating aperture 1001 of the slot antenna 1010.

The “U” shaped transition 6520 crosses the first longitudinal edge 310 of the slot antenna 1010 an even number of times so that, with our present definitions, the second extending part 652 still crosses the first longitudinal edge 310 an even number of times too.

In variants, other kind of microwave transitions well known from the skilled person can also be considered for tuning the characteristics of the second extending part 652 (tapered sections, etc.).

Referring now to FIG. 4d, we present an antenna feeder according to yet another embodiment of the second variant of the present disclosure.

In the present embodiment, two second extending parts 752a and 752b are present in the antenna feeder 700. Consequently, two RF current loops exist when the RF current fed by (or retrieved from) the driving circuit 141A, 142A, 143A, 144A, 145A goes through the common part 450:
a first RF current loop goes through the 1^{st} second extending part 752a and through the RF electrical path in the ground plane (through the RF short-circuit 454) to go back to the common part 450 via the first extending part 451;
a second RF current loop goes through the 2^{nd} second extending part 752b and through the RF electrical path in the ground plane (through the RF short-circuit 454′) to go back to the common part 450 via the first extending part 451.

It thus results that two resonant frequencies exist for coupling the antenna feeder 700 to the radiating aperture 1001 of the slot antenna 1010, thus leading to a dual-band capability for the antenna feeder 700.

The same design guidelines disclosed above in relation with FIG. 3b apply here equally for tuning the characteristics of both of the RF current loops.

In variants, additional second extending parts may be considered for obtaining additional resonant frequencies.

Referring now to FIG. 4e, we present an antenna feeder according to another embodiment of the second variant of the present disclosure.

In the present embodiment, the 1^{st} second extending parts 752a comprises an active component 500 (e.g. a varactor, a diode, a transistor) allowing changing its electrical length according to a command signal.

Consequently, a frequency and/or radiation pattern tunable antenna may be realized in that way.

In variants, such active component can be implemented in different second extending parts when existing, thus allowing to make tunable the different resonant frequencies corresponding to the different second extending parts.

In all the embodiments disclosed above in relation with FIGS. 3a, 3b, 3c and 4a, 4b, 4c, 4d and 4e, the housing can be whether metallic, and the radiating aperture (slot) 1001 is formed in the metallic housing, or whether non-metallic, and the radiating aperture (slot) 1001 is formed in an electrical surface of an element different from the housing (e.g. realized according to a printed circuit board technology or a metal stamping technology).

Electronic device 100 can also be any other electronic device comprising an antenna or antenna feeder as described, such as a gateway, a tablet, a smartphone, a head-mounted display for instance.

Although the description has been done with a housing realized in metal, the person ordinarily skilled in the art will understand that the housing can also be realized in non-metallic materials (such as plastic, ceramic, glass, organic materials, etc.) whose surface is being metallized, therefore obtaining the same effects, except the increased robustness and thermal efficiency for some materials.

1. An electronic device comprising:
a slot antenna formed by a slot comprising first and second longitudinal edges,
an antenna feeder configured for feeding said slot antenna, and
a driving circuit for said antenna feeder,
characterized in that the slot antenna comprises a transmission line forming at least one RF current loop, a part of a surface of said at least one RF current loop facing said slot for electromagnetically coupling said antenna feeder to said slot.

2. The electronic device according to claim 1, wherein said housing is metallic or metallized and wherein said slot is formed in said metallic or metallized housing.

3. The electronic device according to claim 1, wherein said housing is non-metallic and wherein said slot is formed in an electrical surface of an element different from said housing.

4. The electronic device according to claim 1, wherein said housing comprises a first part of housing integrating said first longitudinal edge and a second part of housing integrating said second longitudinal edge, and wherein said transmission line is configured to be held mechanically by a support integrated to, or attached and electrically connected to, said first part of housing.

5. The electronic device according to claim 1, wherein said transmission line comprises at least two RF current loops, a part of a surface of each of said at least two RF current loops facing said slot for electromagnetically coupling, in a particular frequency band, said antenna feeder to said slot.

6. The electronic device according to claim 1, wherein said transmission line comprises:
a common part configured to be electrically connected to said driving circuit;
a first extending part, extending from said common part and ending by a first RF short-circuit via an electrical connection to a conducting element; and
at least one second extending part, extending from said common part and ending by a second RF short-circuit via an electrical connection to said conducting element;
said first and second RF short-circuits being located on a same side of said first longitudinal edge.

7. The electronic device according to claim 6, wherein said first extending part doesn't cross said first longitudinal edge, and wherein said at least one second extending part crosses an even number of times said first longitudinal edge.

8. The electronic device according to claim 6, wherein said first extending part has a length lower than one tenth of a guided wavelength at a working frequency f1.

9. The electronic device according to claim 6, wherein said at least one second extending part has a length lower than one quarter of a guided wavelength at a working frequency f1.

10. The electronic device according to claim 6, wherein said transmission line comprises at least two second extending parts each participating to a particular RF current loop, and wherein each second extending part has a length higher than half of a guided wavelength at a particular working frequency.

11. The electronic device according to claim 6, wherein said at least one second extending part crosses an even number of times said second longitudinal edge.

12. The electronic device according to claim 1, wherein said transmission line comprises:
a first part electrically connected to said driving circuit; and
a second part extending from the first part and having a form of a loop configured for partially facing said slot.

13. The electronic device according to claim 1, wherein said transmission line is realized according to a printed circuit board technology.

14. The electronic device according to claim 1, wherein said transmission line is a piece of metal or a metalized plastic element.

15. The electronic device according to claim 1, wherein said transmission line comprises at least one active component for realizing a frequency and/or radiation pattern tunable slot antenna.
